(19) United States
(12) Patent Application Publication
(10) Pub. No.: US 2025/0299558 A1
(43) Pub. Date: Sep. 25, 2025

(54) THREAT DETECTION AND REPORTING SYSTEM AND METHOD USING AUGMENTED-REALITY GLASSES

(71) Applicants: Je Kwon Yoon, San Jose, CA (US); Hyeonsoo Moon, Seoul (KR); Myung Geon Chung, Seoul (KR)

(72) Inventors: Je Kwon Yoon, San Jose, CA (US); Hyeonsoo Moon, Seoul (KR); Myung Geon Chung, Seoul (KR)

(21) Appl. No.: 19/084,807

(22) Filed: Mar. 20, 2025

Related U.S. Application Data
(60) Provisional application No. 63/568,404, filed on Mar. 21, 2024.

(51) Int. Cl. G08B 25/01; G02B 27/01; G08B 21/02; G08B 25/00; G08B 25/10

(52) U.S. Cl. CPC G08B 25/016; G02B 27/0101; G02B 27/017; G08B 21/02; G08B 25/006; G08B 25/10; G02B 2027/0138; G02B 2027/014; G02B 2027/0178

(57) ABSTRACT

A threat detection and reporting system and method using AR glasses is disclosed. The system includes AR glasses configured to analyze sensor data of at least two built-in sensors to identify a threat and transmit information indicating the identified threat in real time, a smart device configured to receive the information indicating the threat in real time from the AR glasses and reports the threat in real time, and a threat detection platform configured to perform reporting to a relevant organization according to a threat reported in real time from the smart device.

### TECHNICAL FIELD

The present disclosure relates to a threat detection and reporting system and method, and more specifically, to a threat detection and reporting system and method using augmented-reality (AR) glasses.

### BACKGROUND OF THE INVENTION

Conventional CCTV systems with fixed installation locations can detect various accidents or threats by utilizing object and/or voice recognition technologies. However, since the installation locations are fixed, there is a high possibility of having blind spots or not able to detect threats far distanced from the device. In addition, CCTV may have a low resolution of recorded images and thus may not accurately detect threatening objects. It is difficult to clearly identify the face of a criminal, and the system may not able to collect high-quality voice evidence in cases where the threats occur at a distance. To overcome such limitations of existing CCTV systems, here are attempts to attempts have been made to accurately accurately detect such threats at close range using cameras or microphones of AR glasses. However, the threat detection function using such AR glasses may mis-identify simple sounds, such as music similar to gunshots, dialogue in movies, and explosions, as threats. If false positive detections increase on a commonly used device platform, such as AR glasses, it could lead to unnecessary 911 calls, wasting law enforcement resources. Additionally, people facing real threats may not receive the necessary help from authorities in time.

Specifically, current AR glasses technologies rely solely on single sensor such as a microphone or a camera to detect threats, which reduces accuracy. Additionally, they lack the ability to comprehensively analyze various types of sensor data such as GPS, motion sensors, and heart rate sensors installed in electronic devices worn or possessed by a consumer in addition to AR glasses.

Furthermore, if the threat detection feature of the AR glasses is continuously activated, the overall lifetime of the device may be decreased due to increased battery consumption. Given the limited battery capacity of AR glasses, maintaining real-time threat detection for an extended period is challenging.

Non-urgent but sudden motions may also be mistakenly recognized as threats if available sensor data are utilized to make a comprehensive decision. For example, a user's rapid movements or jumping at a music concert may be detected as a threat. To prevent such false detections, a function that accurately differentiates environmental changes from actual threats is required.

Detecting objects solely through computer vision technologies also has limitations in identifying actual threats. For example, AR glasses may recognize scenes on a TV screen as real threats if they contain violent objects such as guns or knives. Such common action movie genres may increase the false positive rate and waste law enforcement resources if the system cannot accurately classify non-real threat scenarios.

### SUMMARY OF THE INVENTION

An objective of the present disclosure is to provide a threat detection and reporting system using AR glasses. Another objective is to provide a corresponding threat detection and reporting method. A threat detection and reporting system utilizing AR glasses, in accordance with the present disclosure, including AR glasses configured to analyze sensor data of at least two built-in sensors to identify a threat and transmit information in real time. The system further includes a smart device configured to receive the transmitted threat information from the AR glasses and report the threat in real time.

The threat detection and reporting system may further include a threat detection platform configured to report threats to relevant organization in real time based on threat data received from the smart device.

The AR glasses may include a microphone configured to receive user voice/surrounding sound, a camera configured to capture the user's field of view (FOV), an application processor unit (APU) configured to synchronize the user voice, surrounding sounds, and captured images, and detect a threat based on the synchronized and stored data. The AR glasses may further include a memory unit configured to store the synchronized user voice, surrounding sounds, and captured images processed by the application processor unit, and a wireless communication module configured to transmit threat information detected by the application processor unit to a smart device in real time.

The application processor unit may be configured to monitor remaining power of a battery in real time and independently activate/deactivate operations of the microphone and the camera in real time on the basis of real-time monitoring results.

The application processor unit may be configured to activate the camera in real time when the user voice and/or surrounding received through the microphone indicates a potential threat.

The application processor unit may be configured to detect an object within the captured field of view and determine whether the object is real or displayed on a screen to assess the presence or absence of a threat.

A threat detection and reporting system utilizing AR glasses, in accordance with the present disclosure, includes AR glasses configured to synchronize sensor data from at least two built-in sensors and transmit the synchronized data in real time. The system further includes a smart device configured to receive the synchronized sensor data, analyze it to determine the occurrence of a threat, and report any identified threat in real time.

The threat detection and reporting system may further include a threat detection platform configured to report to a relevant organization based on real-time threat data received from the smart device.

The threat detection and reporting system may further include at least one wearable device configured to detect a user's biosignal or motion and transmit at least one of the detected biosignal or motion data to the smart device in real time.

The system may support multiple wearable devices worn by a user, including but not limited to a smartwatch, smart ring, and other biosignal or motion-sensing wearables. A wearable device may include a smartwatch or smart ring configured to detect hand motion and a heart rate sensor configured to measure the user's heart rate.

The AR glasses may include a microphone to receive user voice and surrounding sounds, an application processor unit (APU) to synchronize the received audio with a field of view image, a memory unit to store the synchronized data, and a wireless communication module to transmit the stored data to a smart device.

The smart device may be configured to receive at least one of a biosignal or motion from a wearable device, assess whether the received data indicates a potential threat, and activate the AR glasses' threat detection feature for further threat evaluation.

The smart device may be configured to receive a biosignal or motion, user voice and surrounding sounds, and a field-of-view (FOV) image from the AR glasses when the threat detection mode is activated. The smart device may analyze the received data and identify a threat based on the analysis results.

The application processor unit may be configured to monitor remaining power of a battery in real time, and dynamacally activate or deactivate the microphone and camera based on real time on monitoring results.

The application processor unit may be configured to activate the camera in real time when user voice or surrounding sound received through the microphone indicates a potential threat.

The application processor unit may be configured to detect an object within the field of view image and determine whether it is a real object or an object displayed on a screen to assess the presence or absence of a threat.

In addition, by analyzing facial expressions or poses people within the field of view image, the system can enhance threat assessment beyond simple object detection.

A method for determining a threat may utilize the application processor unit of AR glasses, the microprocessor unit or an application processor unit of a smart device, or, if necessary, the computing power of a cloud-based threat detection platform. Additionally, threat determination may be partially processed by embedded digital signal processors (DSPs) within individual sensors before being analyzed by a higher-level processing unit.

A threat detection and reporting method using AR glasses includes analyzing sensor data from at least two built-in sensors to identify a threat, transmitting threat information to a smart device in real time, and reporting the threat to a threat detection platform via the smart device in real time.

The threat detection and reporting method may further include, by the threat detection platform, reporting a the at to a relevant organization based on real time data received from the smart device.

A threat detection and reporting method using AR glasses includes detecting a user's biosignal or motion via a wearable device and transmitting at least one of the detected biosignal or motion to a smart device in real time. The smart device then receives the transmitted biosignal or motion, determines whether it corresponds to a potential threat, and activates the AR glasses' threat detection feature if necessary. Once activated, the AR glasses synchronize sensor data from at least two built-in sensors and transmit the synchronized data to the smart device in real time. The smart device analyzes the received biosignal, motion, and sensor data to determine whether a threat has occurred and, if a threat is identified, reports it to a threat detection platform in real time.

The threat detection and reporting method may further include the threat detection platform reporting a threat to a relevant organization based on real-time data received from the smart device.

A method of determining a threat may utilize the application processor unit of AR glasses, the microprocessor unit or an application processor unit of a smart device, or, if necessary, the computing power of a cloud-based threat detection platform.

### Advantageous Effects

According to the described threat detection and reporting system and method using AR glasses, threats can be detected comprehensively by integrating various sensor data from the AR glasses. Additionally, by incorporating sensor data from multiple wearable devices, the system significantly reduces false threat detections through comprehensive analysis. Furthermore, the AR glasses operate in a low-power state and switch to threat detection mode in response to gunshots, screams, or calls for help, enhancing battery efficiency and mitigating battery lifespan limitations.

This invention enables the practical implementation of threat detection and reporting features on real-world AR Glass devices, ensuring their applicability in operational environments.

### BRIEF DESCRIPTION OF THE DRAWINGS

FIG. 1 is a block diagram of a threat detection and reporting system using AR glasses according to an embodiment of the present disclosure.

FIG. 2 is a flowchart illustrating how the system operates when a threat detection feature is enabled.

FIG. 3 is a flowchart specifically illustrating how false positives are minimized by combining various types of available image, audio, and sensor data.

FIG. 4 shows a use case illustrating a situation in which an AR glasses user watches a movie with violent scenes on TV, which is not a real threat situation.

FIG. 5 illustrates a use case illustrating a situation in which an AR glasses user is at a concert where screams can be heard, which is not a real threat situation. FIG. 6 is a diagram illustrating a real threat situation in which threating elements are visible from the perspective of an AR glasses wearer.

FIG. 7 is a diagram illustrating a real threat situation where a threatening person appears in front of a TV object from the perspective of an AR glasses wearer.

FIG. 8 is a diagram illustrating a real threat situation and what would happen if someone points a gun or a knife at the back of an AR glasses wearer.

FIG. 9 is a flowchart of a threat detection and reporting method using AR glasses according to an embodiment of the present disclosure.

FIG. 10 is a flowchart of a threat detection and reporting method using AR glasses according to another embodiment of the present disclosure.

### DETAILED DESCRIPTION

Reference will now be made in detail to various embodiments, examples of which are illustrated in the accompanying drawings. While the disclosure is susceptible to various modifications and alternatives, specific embodiments are presented as examples in the drawings. However, the disclosure is not limited to these embodiments but, encompasses all modifications, equivalents, and alternatives that fall within the spirit and scope of the invention. Throughout the drawing, reference numerals are used to denote for clarity and consistency.

While terms, such as “first”, “second”, “A”, and “B” may be used to describe various components, these terms do not impose a specific order or limitation. They are soley used to distinguish one component from another. For example, without departing from the scope of the present disclosure, the “first” component may be referred to as the “second” component, and vice versa. Additionally the term “and/or” encompasses any combination of multiple items or any single item among them.

When an element is described as being “coupled” or “connected” to another element, it should be understood that an intermediary element may be present between them, unless explicitly stated otherwise. Conversely, when an element is described as “directly coupled” or “directly connected” to another element, it indicates that no intermediary element is present.

The terms used in this disclosure serve to describe specific embodiments and are not intended to limit its scope. Unless explicitly stated otherwise, a singular reference to an element should be interpreted to include multiple elements. Additionally, as used herein, the terms “comprise” and “include” denote the presence of specified features, integers, steps, operations, elements, components, and/or combinations thereof, without excluding the possibility of additional features, integers, steps, operations, elements, components, and/or combinations.

Unless otherwise defined, all terms including technical and scientific terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, a preferred embodiment according to the present disclosure will be described in detail with reference to the accompanying drawings.

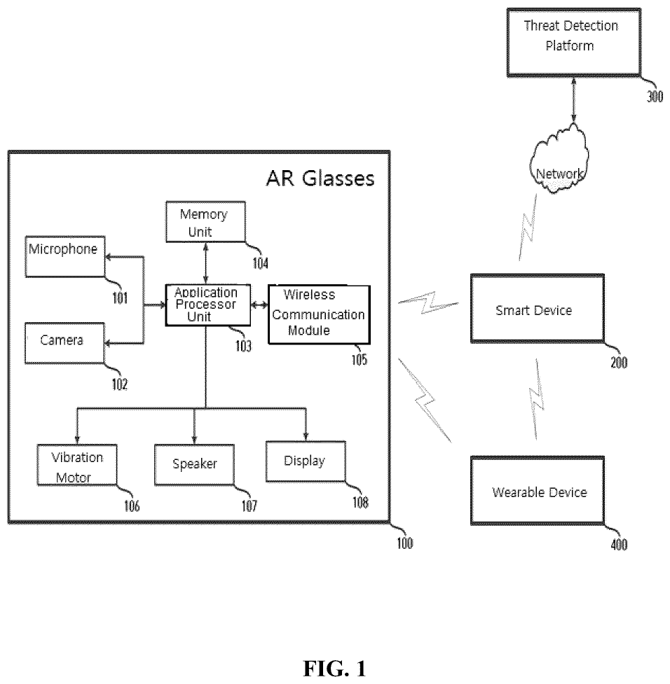

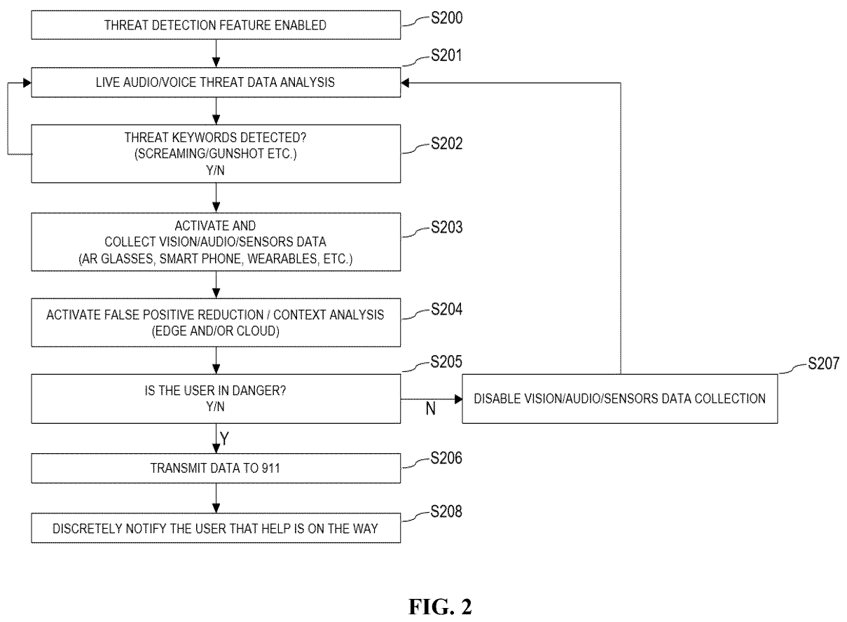

FIG. 1 is a block diagram of a threat detection and reporting system using AR glasses according to an embodiment of the present disclosure.

Referring to FIG. 1, the threat detection and reporting system using AR glasses according to an embodiment of the present disclosure may include AR glasses 100, a smart device 200, a threat detection platform 300, and a wearable device 400.

Here, the threat detection and reporting system may perform threat detection directly by the AR glasses 100, or may perform threat detection by the smart device 200 or the threat detection platform 300. At this time, the threat detection and reporting system may perform threat detection by synchronizing and analyzing at least two pieces of sensor data.

Various types of sensor data detected by the wearable device 400 may also be used for threat detection.

Hereinafter, a first embodiment in which threat detection is performed by the AR glasses 100 will be described first.

The AR glasses 100 may be configured to analyze sensor data from at least two built-in sensors to identify threats and transmit the identified threats to the smart device 200 in real time. The smart device 200 may be configured to receive threats from the AR glasses 100 in real time and report the threats received in real time to the threat detection platform 300.

The threat detection platform 300 may be configured to report to a relevant law enforcement agency based on a threat reported in real time from the smart device 200.

The AR glasses 100 may include a microphone 101, a camera 102, an application processor unit 103, a memory unit 104, a wireless communication module 105, a vibration motor 106, a speaker 107, and a display 108.

The detailed configuration will be described below.

The microphone 101 may be configured to receive user voices/surrounding sounds.

The camera 102 may be configured to capture field of view images.

The application processor unit 103 may be configured to synchronize a user voice/surrounding sound and a field of view image and detect a threat using synchronized and stored user voices/surrounding sounds and field of view images.

Here, the application processor unit 103 may be configured to monitor the remaining power of a built-in battery in real time and independently activate/deactivate the operations of the microphone 101 and the camera 102 in real time based on the real-time monitoring results.

The application processor unit 103 is configured to monitor remaining battery power in real time and independently activate or deactivate operations of the microphone 101 and camera 102 in real time based on the real-time battery monitoring results and user-defined power-saving preferences.

The threat detection system allows users to configure power modes based on their priorities rather than relying solely on remaining battery levels. If a user prioritizes threat detection, the system ensures uninterrupted monitoring by remaining active even when the battery battery reaches a critically low level. In this configuration, high-power features such as camera activation may be triggered more easily, even at lower confidence levels, to enhance responsiveness in potential threat situations. Alternatively, a balanced approach can be applied, where battery-consuming features like camera activation or continuous audio analysis are only triggered when a potential threat is detected with a moderate to high confidence level, optimizing both power efficiency and detection accuracy. A power-saving configuration may also be set, where high-energy functions remain deactivated unless an imminent threat is detected with high confidence, thereby conserving battery life. By providing these configurable options, the system enables users to balance security and power consumption according to their needs and preferences.

In addition, the application processor unit 103 may be configured to activate the camera 102 in real time when the user voice/surrounding sound input from the microphone 101 corresponds to a threat.

The memory unit 104 may be configured to store user voices/surrounding sounds and field of view images synchronized by the application processor unit 103.

The wireless communication module 105 may be configured to transmit the threat detected by the application processor unit 103 to the smart device 200 in real time.

The vibration motor 106 may be configured to output various notifications through vibration.

The speaker 107 may be installed in a frame of the AR glasses 100 near the user's ear and may output sounds or voices that only the user can hear through a small output.

The display 108 may be configured using micro LEDs installed in the glasses and may output various types of text or images.

Hereinafter, a second embodiment in which threat detection is performed by the smart device 200 will be described.

The AR glasses 100 may be configured to synchronize sensor data of at least two built-in sensors and transmit the same in real time to the smart device 200.

In this case, the AR glasses 100 may include the microphone 101, the camera 102, the application processor unit 103, the memory unit 104, and the wireless communication module 105.

The microphone 101 may be configured to receive user voices/surrounding sounds.

The camera 102 may be configured to capture field of view images.

The application processor unit 103 may be configured to synchronize user voices/surrounding sounds received from the microphone 101 and field of view images.

The memory unit 104 may be configured to store the user voices/surrounding sounds and the field of view images synchronized by the application processor unit 103.

The wireless communication module 105 may be configured to transmit user voices/surrounding sounds and field of view images stored in the memory unit 104 to the smart device 200.

The smart device 200 may be configured to receive synchronized sensor data from the AR glasses 100 in real time, analyze and identify whether a threat has occurred using the sensor data received in real time, and report the identified threat to the threat detection platform 300 in real time.

The threat detection platform 300 may be configured to perform a report to a relevant agency based on a threat reported in real time from the smart device 200. The threat detection platform 300 may be configured to transmit a report completion message to the smart device 200 after the report is completed. The smart device 200 may be configured to transmit the report completion message to the AR glasses 100 in real time, and the AR glasses 100 may be configured such that the application processor unit 103 notifies that the report is completed through vibration, voice, or text when the report completion message is received. The AR glasses 100 may output vibration through the vibration motor 106 or output a small voice through the speaker 107, and may output text notifying that the report is completed through the display 108.

The wearable device 400 may be configured to detect a user's biosignal or user's motion and transmit at least one of the detected biosignal or motion to the smart device 200 in real time.

Here, the wearable device 400 may include a smart watch or a smart ring that detects motion of the user's hand, and may be configured to include a heart rate sensor for detecting the user's heart rate.

The smart device 200 may be configured to receive at least one of a biosignal or motion from the wearable device 400, determine whether the received biosignal or motion corresponds to a threat, and switch the AR glasses 100 to a threat detection feature upon determining that the received biosignal or motion correspond to a threat.

Further, the smart device 200 may be configured to receive a biosignal or motion, user voice/surrounding sound, and a field of view image from the AR glasses 100 switched to the threat detection feature, analyze the received biosignal or motion, user voice/surrounding sound, and field of view image, and identify a threat based on analysis results.

In addition, the application processor unit 103 may be configured to monitor the remaining power of the battery in real time, and independently activate/deactivate the operations of the microphone 101 and the camera 102 in real time based on real-time monitoring results.

Further, the application processor unit 103 may be configured to activate the camera 102 in real time when the user voice/surrounding sound input from the microphone 101 correspond to a threat.

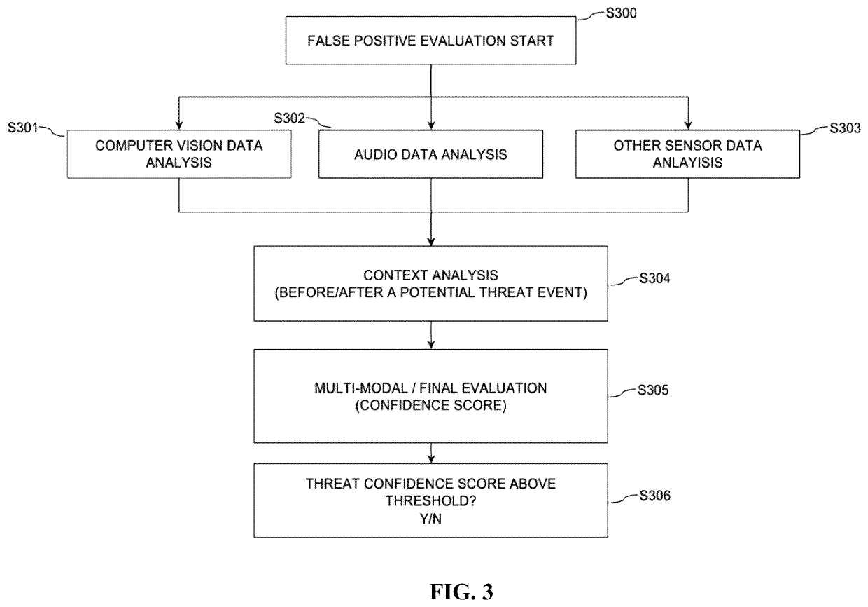

FIGS. 2 to 8 are schematic diagrams of a threat detection algorithm using AR glasses according to an embodiment of the present disclosure.

FIG. 2 is a flowchart illustrating how to practically operate the threat detection system while minimizing battery power usage in the AR glasses 100. The AR glasses 100 analyze surrounding voices and user voices in real time S201 when the threat detection feature is enabled S200.

Upon determining that the result of live audio/voice threat data analysis in step S201 is determined to be threatening S202, the system shifts its focus from battery conservation to accurate threat detection. Sensor data of the camera and sensor of the AR glasses, as well as from the smart device 200 or the wearable device 400 carried by the AR glasses user, is then collected S203.

To minimize false positives in the threat detection system, a comprehensive analysis of various images, images, audio, and sensor data is performed S204. Finally, determination is made as to whether a threat situation has occurred whether a threat situation has occurred is determined S205.

If the AR glasses 100 user is not in a threat situation S207, the camera, etc. are disabled to original states before the threat situation is determined in order to minimize the power usage of the AR glasses, the smart device 200, and the wearable device 400.

However, if the threat detection system determines that there is a real threat, the threat detection system reports to a law enforcement agency, and if necessary, transmits some of the collected video and audio data S206.

In addition, after the report is completed, the threat detection system discretely notifies the AR glasses user that the report is completed through small audio, text display, or specific vibration patterns that only the user can hear or see such that the user can take necessary measures to buy time until the law enforcement agency arrives at the scene S208.

FIG. 3 illustrates a multimodal algorithm designed to reduce incorrect threat detection analysis. Relying on a single type of data for threat analysis makes it difficult to achieve the accuracy needed for practical use. Therefore, the figure describes how at least two types of data can be utilized to improve detection reliability

In the case of computer vision data analysis S301 performed on data collected from the AR glasses 100, image analysis can extract information such as presence of guns, knives, people, TVs, as well as the poses and facial expressions of surrounding individuals. This enables the system to determine whether a threatening object, such as a gun or knife, is being directed at the AR glasses 100 user. In addition, depth analysis using images can help determine the presence of a large flat TV, allowing the system to distinguish whether a potential threat is a real three-dimensional person or merely an image of a person displayed on the TV.

In the case of audio data analysis S203, the system can detect AR glasses user's speech, identify screams, gunshots, or threatening words, and analyze the sound to determine whether the frequency originates from a real person speaking or is artificially generated by a speaker.

In the case of other sensor data analysis S303, the system utilizes sensor data from all electronic devices carried by the AR glasses 100 wearer. This includes data from motion sensors, bio sensors, GPS, and other sources. By analyzing various types of sensor data, the system can determine whether the user's heart rate increases rapidly, if the user bends down and runs away, raises one or both hands in a surrender gesture, moves quickly, or exhibits other behaviors indicative of a potential threat. Abnormal increases in sensor data may be used as an indicator of such threats.

However, to significantly reduce false positives, the determination should not rely solely on a single type of data, such as vision S301, audio S302, or sensor data S303. Instead, it is necessary to analyze the broader context of a potential threat by monitoring data both before and after the initial detection of a potential threat S304.

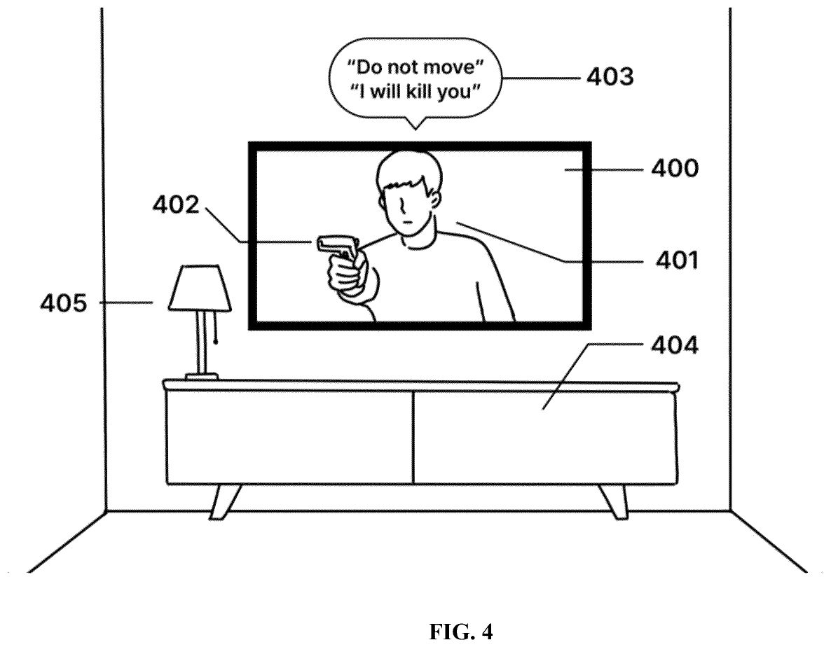

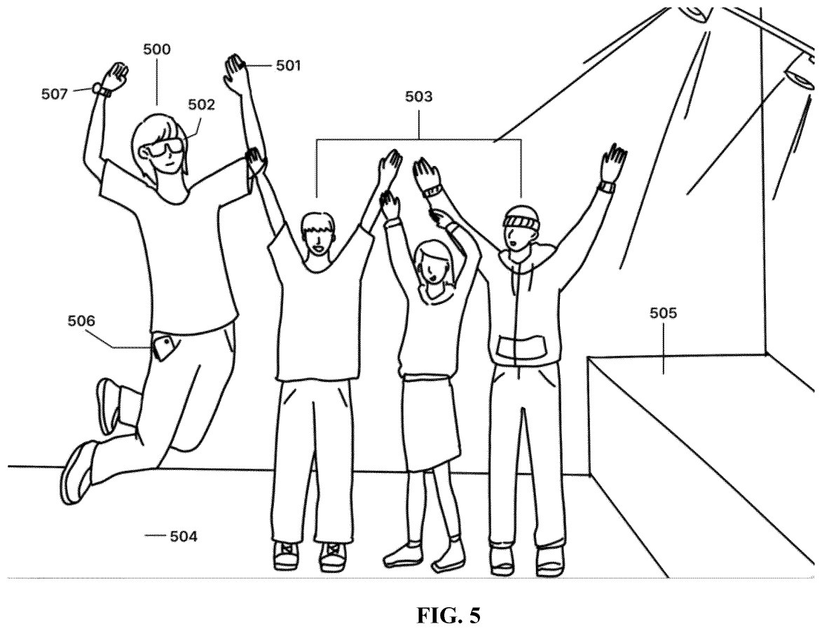

An exemplary method of determining a context is to assign a confidence score to a result determined in each modal S305, and only when the final averaged confidence score exceeds a set threshold score, the potential threat data can be determined as a real threat S306. A more detailed example of FIG. 3 will be described using FIGS. 4 to 8.

In the case of FIG. 4, the content on TV does not actually pose a threat to an AR glass user. However, there is a person 401 who poses a threat, a gun 402 is aimed at the AR glass user, and the sound heard as a voice 403 can be determined as threatening. An example of determining whether there is a real threat by utilizing the false positive reduction algorithm in FIG. 3 will be described.

In the case of computer vision data analysis S301, the following aspects can be determined.
A flat large TV object 400 is detected.
A person 400 is detected only within the TV area.
A gun object 401 is directed at the AR glass user.
No change in the motion of the AR glass user (before/after the threat situation).
No signs of people running away near the AR glasses user are detected.
No image of an AR glasses wearer bending down or running away in response to threat is detected (before/after the threat situation).
A user's main residence is determined from a light stand 405 and a TV stand 404.

In the case of audio data analysis S302, the following aspects can be determined.
Threatening words 403 are detected, but the sound is determined to be artificially generated from a speaker.
No gun or screaming sound is detected.
Registered voice of the AR glasses is not heard (before/after the threat situation)

The following situations can be determined based on the results of sensor data analysis S303.
No motion detected from AR glasses, smart devices, or wearable devices (remained stationary on the sofa/couch)
No change in heart beat rate/GPS data

The multi-modal/finale valuation S305 in FIG. 3 comprehensively determines the situation before/after a threat situation, and the following confidence scores can be generated.
Vision threat confidence score contribution (20/100)
Audio threat confidence score contribution (15/100)
Sensor threat confidence score contribution (10/100)

Averaged confidence score=(20+15+10)/3=15 can be expressed. A predefined threshold confidence score of 90 is required to determine a real threat. Since the score score measured through FIG. 4 is 15, which is below 90, the situation shown in FIG. 4 is determined not to be a real threat.

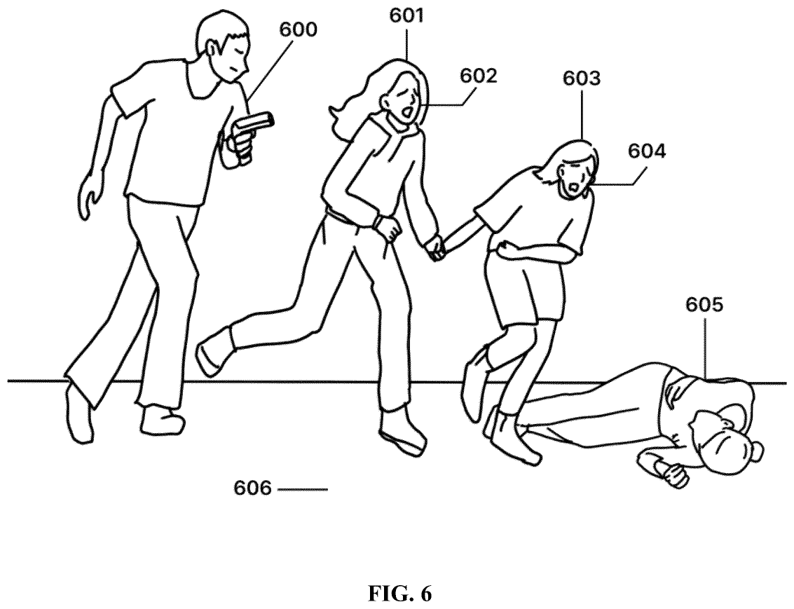

The case shown in FIG. 5 illustrates a scenario where an AR glasses user hears people screaming in a noisy environment, such as a concert or club. As this is not a real threat, it does not require reporting to law enforcement or relevant organization.

The wearer 500 of the AR glasses 502 may carry various peripheral devices such as a smart watch 507, a smart ring 501, and a smart device 506 and may hear screams or shouts from people 503 around them. Loud songs and swear words may also be detected from speakers of a performance stage 505. If only a single type of data collected for threat detection is used to determine a threat, the scenario shown in FIG. 5 could be misclassified as a threat, potentially leading to an unnecessary report to law enforcement agency or relevant organizations.

An example of improving threat detection accuracy and reducing false positives using the algorithm in FIG. 3 will be described.

In the case of computer vision data analysis S301, the following aspects can be determined.
A scenario where the AR glasses user 500 is seen jumping and dancing in various directions (before/after a potential threat situation).
A situation in where surrounding people 503 are dancing with their hands raised, showing no signs of distress or sad facial expressions (before/after a threat situation).
The detected poses of surrounding people 503 do not indicate running away.
The presence of a performance stage 505 is identified.
No specific threatening object, such as gun or knife, is not detected.

In the case of audio data analysis S302, the following aspects can be determined.
A threatening language is detected in the lyrics of a song on the performance stage 505.
Cheering/screaming/shouting sounds of the AR glasses wearer 500 and the surrounding people 503 are detected.
No specific voices requesting help from the wearer of the AR glasses 502 are detected (before/after a threat situation).
No gunshots are detected.
No registered voices from the AR glasses are heard (before/after a threat situation)

The following situation can be determined based on the results of sensor data analysis S303.
Sensors in the AR glasses 502, the smart watch 507, the smart ring 501, and the smart device 506 detect movement data indicating that the user 500 is dancing or jumping energetically. However, no signs of the user bending down or running away are detected.
GPS sensor data confirms that the user is stationary and not running.
Heart rate data remains consistently high before and after the potential threat situation, showing no significant change.

Multi-modal/final evaluation S305 in FIG. 3 comprehensively analyzes the situation before and after a threat situation, and the following confidence scores can be generated.
Vision threat confidence score contribution (40/100)
Audio threat confidence score contribution (35/100)
Sensor threat confidence score contribution (10/100)

Averaged confidence score=(40+65+10)/3=38.3 can be expressed.

A predefined threshold confidence score of 90 is required to determine a real threat. The measured score from FIG. 5 is of 38.3, which is below 90. Thus, the situation shown in FIG. 5 is determined not to be a real threat.

FIG. 6 depicts a shooting incident occurring in a public place, as seen from the perspective of the AR glasses user. A threatening person 600 is holding a gun, while scared expression 602 and a running pose of a person 601, along with frightened expression 604 of a person 603 are detected. Another person 605 is lying on the floor 606, indicating that the person may already be injured. An example of determining a real threat by utilizing the false positive reduction algorithm in FIG. 3 will be described.

In the case of computer vision data analysis S301, the following aspects can be determined.
The person 600 carrying a threatening object such as a gun is found.
People 601 and 603 in the vicinity are running away, and a person 605 is found injured on the ground and unable to move.
The facial expressions of the people 602 and 603 in the vicinity are detected as being scared or crying.
The body poses of the people in the vicinity are detected as running or attempting to flee, such as by bending down. The situation before and after the sound of gunfire differs, indicating a potential threat.
From the perspective of the AR glasses wearer, movement such as quickly bending down is detected, indicating that the wearer may be reacting to a threat by attempting to flee.
TV and flat screens are not found.

In the case of audio data analysis S302, the following aspects can be determined.
The sound of a gunshot is detected.
A scream is continuously detected after the sound of the gun.
The voice of the AR glasses wearer asking for specific help is detected (before/after the threat situation).
Threatening speech of the person with the gun, such as “I will kill you all today!” is detected.
It is determined that the sound is not coming from a speaker.

The following situation can be determined based on the results of sensor data analysis S303.
Sensor data detected from a smart watch, smart ring, and smart device worn by the AR glasses wearer indicate rapid increase in crouching speed and movement following the threatening gunshot sound.
After the gunshot sound, an increased heart beat rate data is detected, and GPS data indicates that the user begins running in a specific direction.

Multi-modal/final evaluation S305 in FIG. 3 comprehensively evaluates the situation before and after the threat situation, and the following confidence scores can be generated.
Vision threat confidence score contribution (97/100)
Audio threat confidence score contribution (95/100)
Sensor threat confidence score contribution (93/100)

Averaged confidence score=(97+95+93)/3=95 can be expressed. A predefined threshold confidence score of 90 is required to determine a real threat. The confidence score measured from FIG. 6 is 95, which exceeds the threshold. As a result, the scenario shown in FIG. 6 is determined to be a real threat situation that must be reported to a law enforcement agency or a relevant organization. After reporting, the AR glasses can notify the user that help is on the way through vibration, a discreet display message, or low-volume audio that only the user can hear

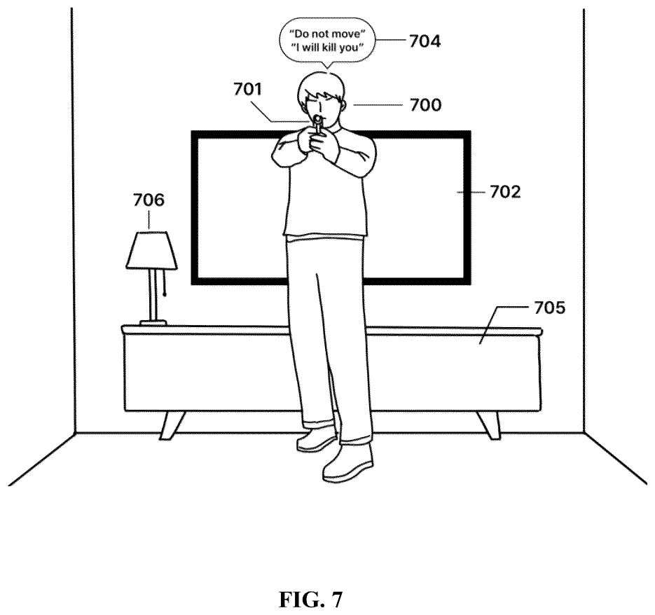

The case of FIG. 7 is somewhat similar to the situation in FIG. 4 However, unlike FIG. 4, this depicts a real threat situation. In this case, an actual person 700, rather than a virtual character on the TV, is pointing a gun 701 at an AR glasses wearer. From the perspective of the AR glasses wearer, a TV 702, a light stand 706, and a TV stand 705 are detected, along with a threatening voice 704. An example of how the false positive reduction algorithm from FIG. 3 can be used to determine whether this is a real threat will be described.

In the case of computer vision data analysis S301, the following aspects can be determined.
A flat large TV object 702 is detected.
A person 700 is detected beyond the TV area.
A gun object 701 is directed toward the AR glasses user.
The AR glasses user is detected raising both arms in a surrendering motion (after a threat situation)
The hands of people watching a movie with the AR glasses wearer are detected as raised in surrendering motion (after a threat situation).
The user's main residence is determined from the audio light 405 and the TV stand 404.

In the case of audio data analysis S302, the following aspects can be determined.
Threatening words 704 are detected and determined to be real, not artificially generated from a speaker.
No gun or screaming sound is detected.
Registered voice of the AR glasses wearer is detected after the threatening person 700 appears in the field of view.

The following situations can be determined based on the results of sensor data analysis S303.
A user's motion of raising both hands to surrender is detected through the AR glasses, smart device, and wearable device.
Heart beat rate data increases rapidly.
It is determined that the user is not moving from GPS data.

Multi-modal/final evaluation S305 in FIG. 3 comprehensively determines a situation before and after the threat situation, and the following confidence scores can be generated.
Vision threat confidence score contribution (97/100)
Audio threat confidence score contribution (85/100)
Sensor threat confidence score contribution (94/100)

Averaged confidence score=(97+85+94)/3=92 can be expressed. A predefined threshold confidence score of 90 is required to determine a real threat. The score of 92 measured in FIG. 7 exceeds this threshold, confirming that the situation should be reported to a law enforcement agency or relevant organization. After reporting, the AR glasses user can be discreetly notified that help is on the way through vibration, a display message, or low-volume audio that only the user can hear.

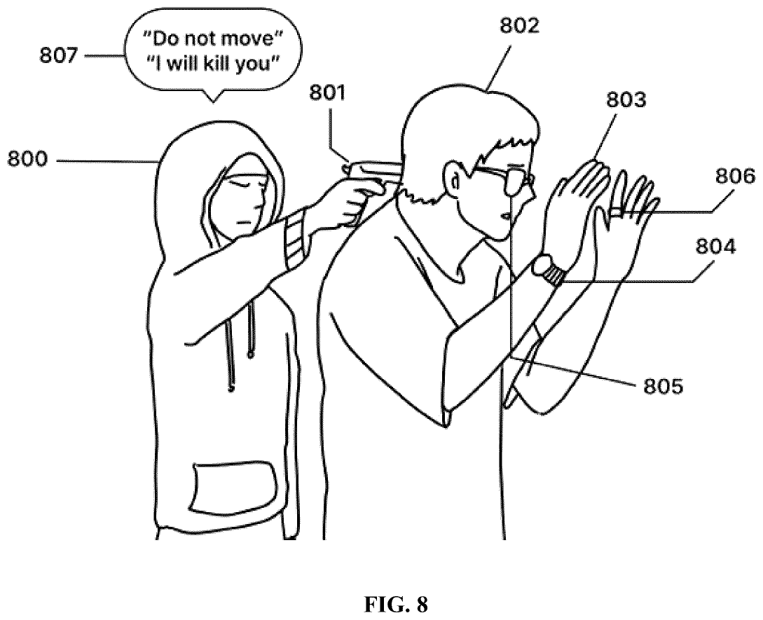

FIG. 8 illustrates a scenario in which a person 800 poses a threat by pointing a gun 801 at an AR glasses user 802 from behind in a sparsely populated area. The AR glasses user 802 is also wearing a smartwatch 804 and a smart ring 806. Since the gun, which presents a potential threat, is not directly visible to the AR glasses user 802, the system may initially determine that this is not a real threat. However, the false positive reduction algorithm in FIG. 3 can be used to further analyze the situation and determine whether a real threat exists. A detailed explanation of this process will be provided.

In the case of computer vision data analysis S301, the following aspects can be determined.
No threatening objects such as a gun and a knife are detected
A user's motion of raising both hands are detected after threatening language is detected.

In the case of audio data analysis S302, the following aspects can be determined.
Threatening words 807 are detected, and analysis confirms that they are not artificially generated from a speaker.
No gun or screaming is detected.
The voice of the registered user of the AR glasses responding to the threat is detected.

The following situations can be determined based on the results of sensor data analysis S303.
A user's motion of raising both hands and surrendering is detected by the AR glasses, smart device, and wearable device.
Heart beat rate data increases rapidly
It is determined that the user is not moving from GPS data.

Multi-modal/final evaluation S305 in FIG. 3 comprehensively determines a situation before and after the threat situation, and the following confidence scores can be generated.
Vision threat confidence score contribution (80/100)
Audio threat confidence score contribution (96/100)
Sensor threat confidence score contribution (98/100)

Averaged confidence score=(97+85+94)/3=91.33 can be expressed. A predefined threshold confidence score of 90 is required to determine a real threat. The score of 91.33 measured in FIG. 8 exceeds this threshold, confirming the situation as a real threat that must be reported to a law enforcement agency or a relevant organization. After reporting, the AR glasses user can be discreetly notified that help is on the way through vibration, display message display, and audio of a volume that only the user can hear, preventing the threating individual from becoming aware of the alert.

Various other algorithms may also be implemented to enhance threat detection capabilities.

For example, when a visually impaired person senses an unknown threat, he or she can inquire about the threat through a microphone 101 on the AR glasses 100. In response, the AR glasses 100 can activate the camera 102 to assess surroundings for potential threats. After analysis, the glasses can provide detailed information about the detected threat through a built in speaker.

As another example, the AR glasses 100 may incorporate self-learning capabilities. The AR glasses 100 can autonomously collect and analyze data stored in memory unit 104, along with data of the smart device 200 and threat detection platform 300 using machine learning. This enables the AR glasses 100 to identify threats independently, without relying on external processing, and transmit relevant evidence to the smart device 200 or the threat detection platform 300.

Additionally, a threat determination algorithm can be implemented on the threat detection platform 300 instead of the AR glasses 100 or the smart device 200. The advantage of this approach is that the threat detection platform 300 can leverage more extensive data processing and training to develop a highly sophisticated threat detection model, improving accuracy and reducing false positives.

In the present disclosure, various learning models such as LLM, sLLM, Vision AI, and Multi-modal vLM, as listed in Table 1 below, can be utilized.

TABLE 1

| | | | | | Target Device |
|---|---|---|---|---|---|
| Items # | Models | Usage | Details | Example Models | (as of today) |
| 1 | LLM | Text(speech) only | Comprehensive/complicated | Open model providers' models | Cloud/mobile phone with |
| | (Large | based threat | analysis (Threat detection | (GPT, Deepseek, Gemini, Liama, | GPU resources |
| | Language | detection (voice) | through direct and indirect | etc.) | |
| | Models) | | conversation analysis) | | |
| 2 | sLM | Text(speech) only | Simple and direct threat | Small LMs with parameters <18 | Light devices (on-device AI) |
| | (Small | based threat | detection (Threatening words, | (smolLM, Qwen0.58, etc.) | (AR glasses, smartwatches, |
| | Language | detection (voice) | specific keywords, etc.) | | smart ring, etc.) |
| | Models) | | | | |
| 3 | Vision AI | Image only based | Image only based threat | YOLO, Vision Transiomers (ViTs), | Light devices (on-device AI) |
| | (Image | threat detection | detection (object detection | ONN based model (classification, | For complicated analysis and |
| | Only) | | is an example) | detection and motion recognition) | better performance model |
| | | | | | cloud based model services |
| | | | | | can be provided. |
| 4 | Multi-modal vLM | Vision + text (or | Threat detection based on | Llava, GPT Vision API, YOLO + | Cloud/mobile phone with |
| | (Vision-Language | speech) based | vision + text (or speech) | Sensor Fusion AI. Vision | GPU resources, AR glasses. |
| | Model) | threat detection | | Transformers (ViTs) for anomaly | IoT security devices, smart |
| | Vision + Text | | | detection, DARPA defense AI | surveillance systems |
| | (or speech) | | | models?? | |

If inference is performed directly on the AR glasses 100, one or more lightweight models, such as sLM or Vision AI, may be used. In contrast, more complex models, such as LLM, Multi-modal vLM, or future AI models with enhanced capabilities, may be utilized on the smart device 200 or the threat detection platform 300. However, as the hardware performance of the AR glasses 100 improves over time, it may become possible to perform inference using multiple models, including emerging AI architectures, directly on the AR glasses 100, enabling more advanced threat detection and analysis.

A threat detected in the smart device 200 or the threat detection platform 300 is provided to the AR glasses 100, and the AR glasses 100 may output a low-volume audio warning through the speaker or output a warning using haptics.

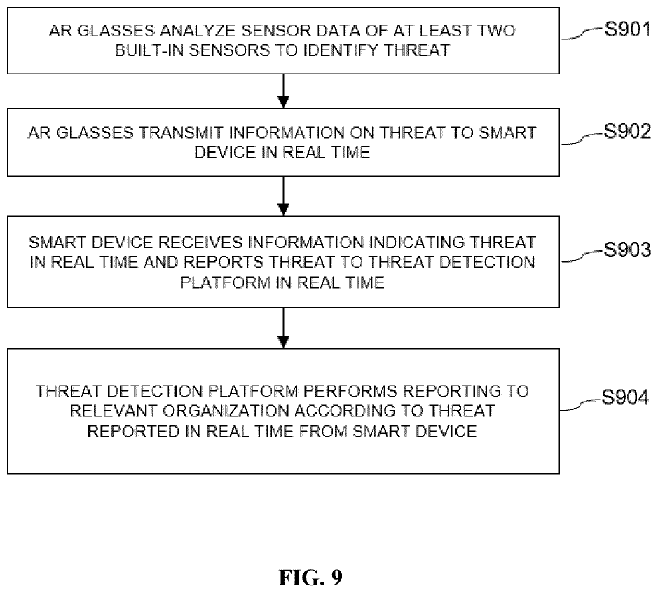

FIG. 9 is a flowchart of a threat detection and reporting method using AR glasses according to an embodiment of the present disclosure.

Referring to FIG. 9, the AR glasses 100 analyzes sensor data of at least two built-in sensors to identify a threat (S901). Subsequently, the AR glasses 100 transmit the identified threat to the smart device 200 in real time (S902).

Subsequently, the smart device 200 receives the threat in real time and reports the received threat in real time to the threat detection platform 300 in real time (S903).

Subsequently, the threat detection platform 300 reports to a relevant organization according to the threat reported in real time from the smart device 200 (S904).

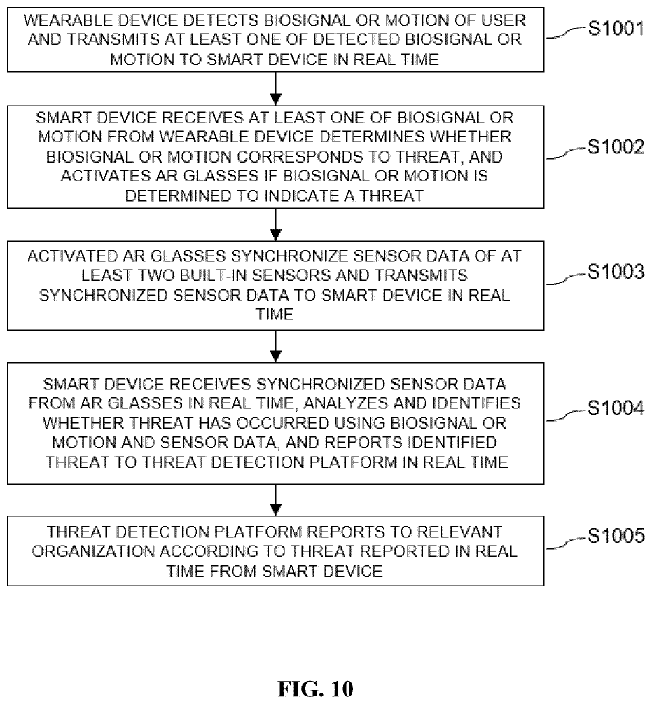

FIG. 10 is a flowchart of a threat detection and reporting method using AR glasses according to another embodiment of the present disclosure.

Referring to FIG. 10, the wearable device 400 detects a biosignal or motion of the user and transmits at least one of the detected biosignal or motion to the smart device 200 in real time (S1001).

Subsequently, the smart device 200 receives at least one of the biosignal or motion from the wearable device 400, determines whether the received biosignal or motion corresponds to a threat, and if the received biosignal or motion is determined to correspond to a threat, activates the threat detection feature of the AR glasses 100 (S1002).

Subsequently, the threat detection mode enabled AR glasses 100 synchronizes sensor data of at least two built-in sensors and transmits the data to the smart device 200 in real time (S1003).

Subsequently, the smart device 200 receives the synchronized sensor data from the AR glasses 100 in real time, analyzes and identifies whether a threat has occurred using the biosignal or motion and the sensor data received in real time, and reports the identified threat to the threat detection platform 300 in real time (S1004).

Subsequently, the threat detection platform 300 reports to a relevant organization according to the threat reported in real time from the smart device 200 (S1005).

Although the disclosure has been described with reference to the above embodiments, those skilled in the art will understand that the disclosure can be modified and changed in various manners within the scope of the disclosure as set forth in the following claims.

What is claimed is:

1. A threat detection and reporting system using AR glasses, comprising:
AR glasses configured to analyze sensor data from at least two built-in sensors, identify a threat, and transmit information about the identified threat in real time; and
a smart device configured to receive the threat information from the AR glasses and report the threat in real time.

2. The threat detection and reporting system of claim 1, further comprising a threat detection platform configured to report to a relevant organization according to a real-time threat information received from the smart device.

3. The threat detection and reporting system of claim 2, wherein the AR glasses comprise:
a microphone configured to receive user voice and/or surrounding sound;
a camera configured to capture the field of view of the AR glasses wearer;
an application processor unit configured to synchronize the user voice, surrounding sound and the field of view image and detect a threat using the synchronized and stored data;
a memory unit configured to store the user voice, surrounding sound and the field of view image synchronized by the application processor unit; and
a wireless communication module configured to transmit detected threat information detected by the application processor unit to the smart device in real time.

4. The threat detection and reporting system of claim 3, wherein the application processor unit is configured to monitor remaining battery power in real time and independently activate or deactivate operations of the microphone and camera in real time based on the real-time battery monitoring results and user-defined power-saving preferences.

5. The threat detection and reporting system of claim 4, wherein the application processor unit is configured to activate the camera in real time when the user voice and/or surrounding sound received through the microphone indicates a potential a threat.

6. The threat detection and reporting system of claim 3, wherein the application processor unit is configured to detect an object in the field of view image and determine whether the detected object is a real object or an object displayed on a screen to determine the presence or absence of a threat.

7. A threat detection and reporting system using AR glasses, comprising:
AR glasses configured to synchronize sensor data from at least two built-in sensors and transmit the synchronized sensor data in real time; and
a smart device configured to receive the synchronized sensor data from the AR glasses in real time, analyze and determine whether a threat has occurred using the sensor data received in real time, and report the identified threat in real time.

8. The threat detection and reporting system of claim 7, further comprising a threat detection platform configured to report to a relevant organization based on real-time threat information received from the smart device.

9. The threat detection and reporting system of claim 7, further comprising at least one wearable device configured to detect a biosignal or motion of a user and transmit at least one of the detected biosignal or motion to the smart device in real time.

10. The threat detection and reporting system of claim 9, wherein the wearable device comprises at least one of:
a smart watch or a smart ring configured to detect a motion of a user's hand; and
a heart rate sensor configured to detect a user's heart rate.

11. The threat detection and reporting system of claim 10, wherein the AR glasses comprise:
a microphone configured to receive user voice and/or surrounding sound;
an application processor unit configured to synchronize the user voice, surrounding sound received through the microphone and a field of view image;
a memory unit configured to store the user voice, surrounding sound, and the field of view image synchronized by the application processor unit; and
a wireless communication module configured to transmit the user voice, surrounding sound and field of view image stored in the memory unit to the smart device.

12. The threat detection and reporting system of claim 11, wherein the smart device is configured to receive at least one of a biosignal or motion from at least one of the the wearable devices, determine whether the received biosignal or motion indicates a potential threat, and switch the AR glasses to a threat detection mode if the received biosignal or motion is determined to indicate to a potential threat.

13. The threat detection and reporting system of claim 12, wherein the smart device is configured to receive at least one of a biosignal, motion, user voice, surrounding sound, and a field of view image from the AR glasses operating in the activated threat detection mode and identify a real threat by analyzing the received data.

14. The threat detection and reporting system of claim 13, wherein the application processor unit is configured to monitor remaining batter power in real time, and independently activate/deactivate operation of the microphone and the camera in real time on the basis of real-time based on the real-time battery monitoring results and user-defined power-saving preferences.

15. The threat detection and reporting system of claim 14, wherein the application processor unit is configured to activate the camera in real time when user voice and/or surrounding sound received through the microphone indicates a potential threat.

16. The threat detection and reporting system of claim 13, wherein the application processor unit is configured to detect an object in the field of view image and determine whether the detected object is a real object or an object displayed on a screen to assess the presence or absence of a threat.

17. A threat detection and reporting method using AR glasses, comprising the steps of:
analyzing sensor data from at least two built-in sensors of AR glasses to identify a threat;
transmitting information indicating the identified threat to a smart device in real time; and
receiving the information indicating the threat in real time and reporting the threat in real time to a threat detection platform in real time by the smart device.

18. The threat detection and reporting method of claim 17, further comprising the step of reporting, by the threat detection platform, a threat to a relevant organization based on real time data from the smart device.

19. A threat detection and reporting method using AR glasses, comprising:
a step in which a wearable device detects a biosignal or motion of a user and transmits at least one of the detected biosignal or motion to a smart device in real time;
a step in which the smart device receives at least one of the biosignal or motion from the wearable device, determines whether the received biosignal or motion correspond to a threat, and activates the AR glasses to a threat detection mode if the received biosignal or motion is determined to correspond to a threat;
a step in which the AR glasses, upon activation of the threat detection mode, synchronize sensor data from at least two built-in sensors and transmit the synchronized sensor data to the smart device in real time; and
a step in which the smart device receives the synchronized sensor data from the AR glasses in real time, analyzes and identifies whether a threat has occurred by integrating the biosignal or motion from the wearable device with the sensor data received from the AR glasses in real time.

20. The threat detection and reporting method of claim 19, further comprising a step of reporting, by the threat detection platform, a threat to a relevant organization based on real time threat data received from the smart device.
